(19) United States
(12) Patent Application Publication
(10) Pub. No.: US 2017/0181060 A1
(43) Pub. Date: Jun. 22, 2017

(54) METHODS AND DEVICES FOR CONNECTING TO NETWORK

(71) Applicant: XIAOMI INC., Beijing (CN)

(72) Inventors: Yang WANG, Beijing (CN); Qiang FU, Beijing (CN); Enxing HOU, Beijing (CN)

(73) Assignee: XIAOMI INC., Beijing (CN)

(21) Appl. No.: 15/386,922

(22) Filed: Dec. 21, 2016

(30) Foreign Application Priority Data
Dec. 21, 2015 (CN) 201510967435.8

(51) Int. Cl. H04W 48/08; H04W 8/18; H04W 76/02; H04W 8/00

(52) U.S. Cl. CPC H04W 48/08; H04W 8/005; H04W 8/183; H04W 76/02

(57) ABSTRACT

Methods and devices are provided for connecting a network. The method may include: receiving device information sent by a smart device, in which the device information is broadcasted by the smart device when the smart device is not connected to the network; generating a network access request carrying the device information; based on a bound user account, sending the network access request to a terminal device on which the bound user account is logged in; receiving a processing result returned by the terminal device with regard to the network access request; and when the processing result indicates that the network is allowed to be accessed, sending connection information of the routing device to the smart device, such that the smart device connects to the network according to the connection information.

### CROSS-REFERENCE TO RELATED APPLICATION

This application is based on and claims priority to Chinese Patent Application Serial No. 201510967435.8, filed with the State Intellectual Property Office of P. R. China on Dec. 21, 2015, the entire content of which is incorporated herein by reference.

### FIELD

The present disclosure relates to the communication technology field, and more particularly to a method and device for connecting to a network.

### BACKGROUND

With a rapid development of the Internet technology, more and more smart devices enter people's life, such as: a smart speaker box, a smart camera, and a smart cooker, etc. Generally, the smart devices may realize functions related to the intellectualization in the case of connecting to network.

Currently, for the smart device provided with a display screen, the process of accessing to the network is relatively simple. However, for the smart device without the display screen, the technical solution of accessing to the network is complex and inconvenient, and the success rate of accessing to the network is poor.

### SUMMARY

In order to solve problems in the related art, the present disclosure provides a method and device for connecting to a network.

According to a first aspect of the present disclosure, a method for connecting to a network is provided. The method includes: receiving device information sent by a smart device, in which the device information is broadcasted by the smart device when the smart device is not connected to the network; generating a network access request carrying the device information; sending the network access request to a terminal device based on the bound user account; receiving a processing result returned by the terminal device with regard to the network access request; and when the processing result indicates that the network is allowed to be accessed, sending connection information of the routing device to the smart device, such that the smart device connects to the network according to the connection information.

According to a second aspect of the present disclosure, a method for connecting to a network is provided. The method includes: when a smart device is not connected to the network, broadcasting device information of the smart device; receiving connection information sent by a routing device; and connecting to the network according to the connection information. Here, the connection information is sent by the routing device after receiving a processing result returned by a terminal device with regard to a network access request, where the processing result indicates that the network is allowed to be accessed, and the network access request is generated by the routing device and carries the device information.

According to a third aspect of the present disclosure, a device for connecting to a network is provided. The device includes: a processor; and a memory, configured to store instructions executable by the processor. The processor is configured to: receive device information sent by a smart device, where the device information is broadcasted by the smart device when the smart device is not connected to the network; generate a network access request carrying the device information; based on a bound user account, send the network access request to a terminal device on which the bound user account is logged in; receive a processing result returned by the terminal device with regard to the network access request; and when the processing result indicates that the network is allowed to be accessed, send connection information of the routing device to the smart device, such that the smart device connects to the network according to the connection information.

According to a fourth aspect of the present disclosure, a device for connecting to a network is provided. The device includes: a processor; and a memory, configured to store instructions executable by the processor. The processor is configured to: when a smart device is not connected to the network, broadcast device information of the smart device; receive connection information sent by a routing device; and connect to the network according to the connection information. The connection information is sent by the routing device after receiving a processing result returned by a terminal device with regard to a network access request, where the processing result indicates that the network is allowed to be accessed, and the network access request is generated by the routing device and carries the device information.

It should be understood that, the above general description and following detail description are exemplary and explanatory, and shall not be construed to limit the present disclosure.

### BRIEF DESCRIPTION OF THE DRAWINGS

These and other aspects and advantages of embodiments of the present disclosure will become apparent and more readily appreciated from the following descriptions made with reference to the drawings.

FIG. 1 shows a schematic diagram of an application scene of a network connection according to an example embodiment.

FIG. 2 shows a flow chart of a method for connecting to a network according to an example embodiment.

FIG. 3 shows a flow chart of another method for connecting to a network according to an example embodiment.

FIG. 4 shows a flow chart of another method for connecting to a network according to an example embodiment.

FIG. 5 shows a block diagram of a device for connecting to a network according to an example embodiment.

FIG. 6 shows a block diagram of another device for connecting to a network according to an example embodiment.

FIG. 7 shows a block diagram of another device for connecting to a network according to an example embodiment.

FIG. 8 shows a block diagram of another device for connecting to a network according to an example embodiment.

FIG. 9 shows a block diagram of another device for connecting to a network according to an example embodiment.

FIG. 10 shows a block diagram suitable for a device for connecting to a network according to an example embodiment.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions.

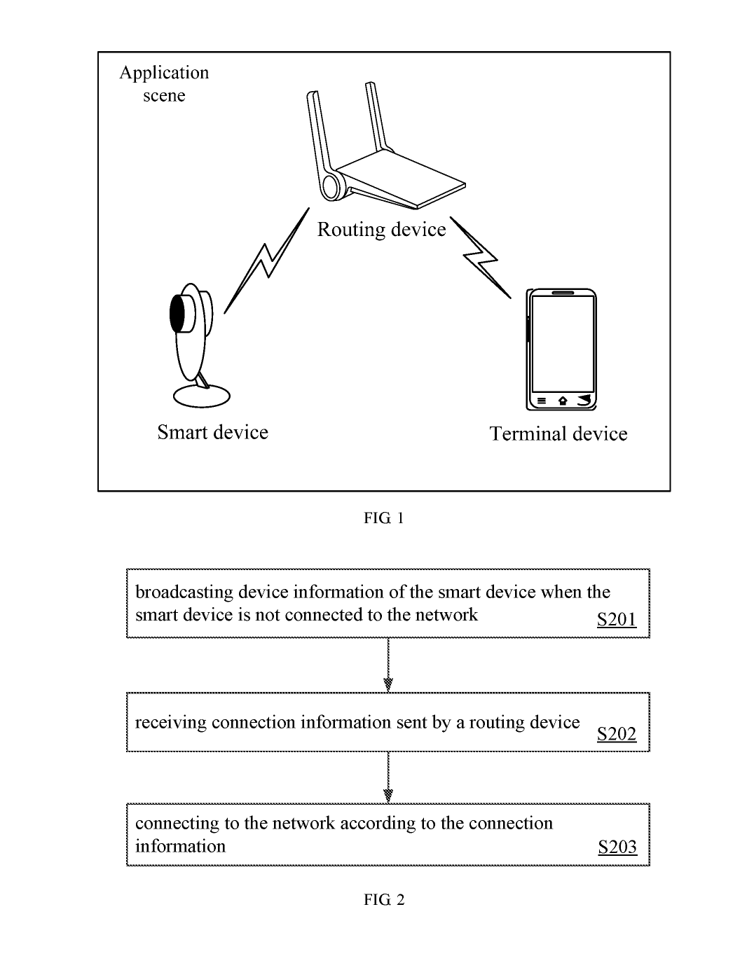

FIG. 1 shows a schematic diagram of an application scene of a network connection according to an example embodiment.

Referring to FIG. 1, smart devices may include various smart homes able to access to the network, such as a smart camera, a smart cooker and a smart speaker box. In the application scene shown in FIG. 1, take the smart device being the smart camera as an example.

A routing device may include a smart network device with a routing function, such as a smart router, a smart three-layer switch, or any electronic device including at least one processor configured to provide a routing function, etc.

A terminal device may include a device like a smart cellphone, a tablet computer, a PDA (Personal Digital Assistant), a PC or the like. The user may realize a management and control on the routing device via client software installed in the terminal device.

FIG. 2 shows a flow chart of a method for connecting to a network according to an example embodiment.

Referring to FIG. 2, the method may be implemented at least partially in the smart device shown in FIG. 1 and includes following steps.

In step S201, when the smart device is not connected to the network, the smart device may broadcast device information of the smart device. For example, the smart device may broadcast the device information using wireless messages in a preset frequency range. The device information may include an identification that identifies the smart device.

In step S202, the smart device may receive connection information sent by a routing device.

In the present embodiment, the connection information may be sent by the routing device after receiving a processing result returned by the terminal device with regard to the network access request, where the processing result may indicate that the network is allowed to be accessed, and the network access request is generated by the routing device and carries the device information.

In step S203, the smart device connects to the network according to the connection information.

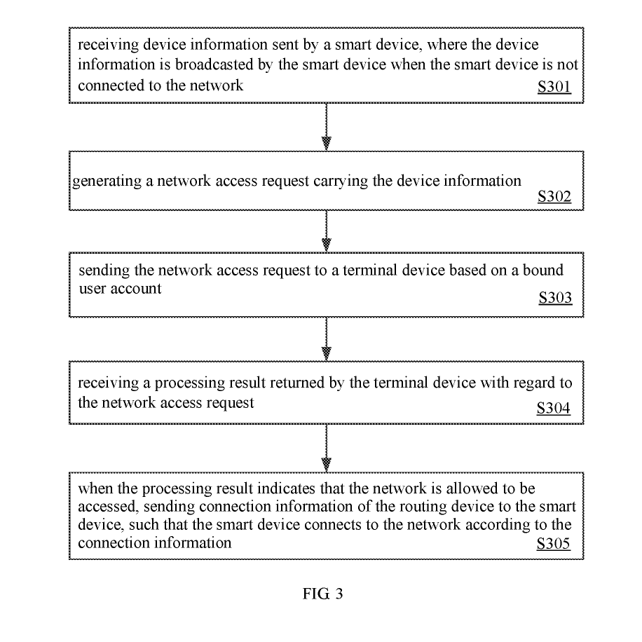

FIG. 3 shows a flow chart of another method for connecting to a network according to an example embodiment.

Referring to FIG. 3, the method may be implemented at least partially in the routing device shown in FIG. 1 and include following steps.

In step S301, device information sent by a smart device is received, in which the device information is broadcasted by the smart device when the smart device is not connected to the network.

In step S302, a network access request carrying the device information is generated.

In step S303, the routing device sends the network access request to a terminal device based on a bound user account. For example, the routing device may send the network access request to a terminal device on which the bound user account is logged in. Additionally or alternatively, the routing device may send the network access request to a terminal device that is identified by the bound user account.

In step S304, the routing device receives a processing result returned by the terminal device with regard to the network access request.

In step S305, when the processing result indicates that the network is allowed to be accessed, the routing device may send connection information of the routing device to the smart device, such that the smart device connects to the network according to the connection information.

According to the above description, in the present disclosure, the routing device may send the network access request carrying the device information to the terminal device after receiving the device information sent by the smart device when the smart device is not connected to the network, and send the connection information for access to network to the smart device after receiving the result indicating that the network is allowed to be accessed returned by the terminal device, such that the smart device may access to the network; in the entire process, the user may perform a network connection confirmation on the smart device via the terminal device without operating the smart device, which may be realized conveniently with good maneuverability, meanwhile, a geographical restriction may be overcome, and a remote control on the network connection of the smart device may be realized.

Alternatively or additionally, in an embodiment of the present disclosure, the device information may include a device name and device ID and other information used for recognizing smart devices. After being started, the smart device may detect whether it is able to connect to the network. Under a condition that it is able to connect to the network, e.g. related information required for the network connection are cached in the smart device, the subsequent schedule may end. Under a condition that it is unable to connect to the network, the smart device may periodically broadcast the device information of the smart device until it is able to access to the network. The period that the smart device sends the device information may be set by a developer, e.g. 1 minute, 3 minutes etc., which shall not be limited herein.

Alternatively or additionally, in another embodiment of the present disclosure, after the routing device which is in the same local area network with the smart device receives the device information sent by the smart device, the network access request carrying the device information may be generated, and then based on the bound user account, the network access request is sent to the terminal device on which the user account is logged in. In the present embodiment, the smart device may send the account information of the user account bound with the device and the network access request to a server, in which, the account information may include information used for recognizing the user account such as an account nickname, an account ID etc. After receiving the account information and the network access request, the server may determine the terminal device on which the corresponding user account is logged in according to the account information, and then forward the network access request to the terminal device on which the user account is logged in. In the present embodiment, when there are multiple terminal devices on which the user account is logged in, the server may forward the network access request to each terminal device on which the user account is logged in. After the terminal device receives the network access request, the network access request may be displayed to the user, e.g. the terminal device may display “the smart camera *** request to access to the network, please confirm” etc. The user may input a processing result indicating that the network is allowed or unallowed to be accessed according to actual situations, and the processing result inputted by the user may be returned to the routing device by the terminal device.

Alternatively or additionally, in another embodiment of the present disclosure, the routing device receives the processing result returned by the terminal device. When the processing result indicates that it is refused to access to the network, the subsequent schedule may end. When the processing result indicates that it is allowed to access to the network, the routing device may send the connection information of the present device to the smart device. The connection information may include: SSID (Service Set Identifier), connection password etc. The routing device may broadcast the connection information, and may unicast the connection information, which shall not be limited in the present disclosure. After receiving the connection information, the smart device may connect to the network based on the connection information.

Alternatively or additionally, in another embodiment of the present disclosure, under a condition that the processing result returned by the terminal device is not received in a preset time period, the routing device may send the network access request to the terminal device on which the user account is logged in again, for example, the account information of the bound user account and the network access request are sent to the server again, and the network access request is forwarded by the server to the terminal device on which the user account is logged in. Under a condition that the processing result returned by the terminal device is still not received by the routing device after being re-sent for a preset number of times, the subsequent schedule may end.

Alternatively or additionally, in another embodiment of the present disclosure, the routing device may bind the user account to the routing device in a below way: the routing device may obtain the account information inputted by the user, and then send the account information to the server, such that the server builds a binding relationship between the user account corresponding to the account information and the routing device after the account information passes a verification. The account information may be inputted by the user in a login interface or a setting interface of the routing device, and may include: an account ID and an account password. For example, the user may input the account ID and the account password in the login interface of the routing device. After obtaining the account information, the routing device may send the account information to the server, and the server performs a verification on the account information. After the verification is passed, the server may build a binding relationship between the user account corresponding to the account information and the routing device. For example, the server may save a mapping relationship between the routing device and the account ID of the user account. Of course, in another embodiment of the present disclosure, other methods may be used for binding the user account to the routing device, which shall not be limited in the present disclosure.

An implementation process of the present disclosure is described below in combination with an application scene.

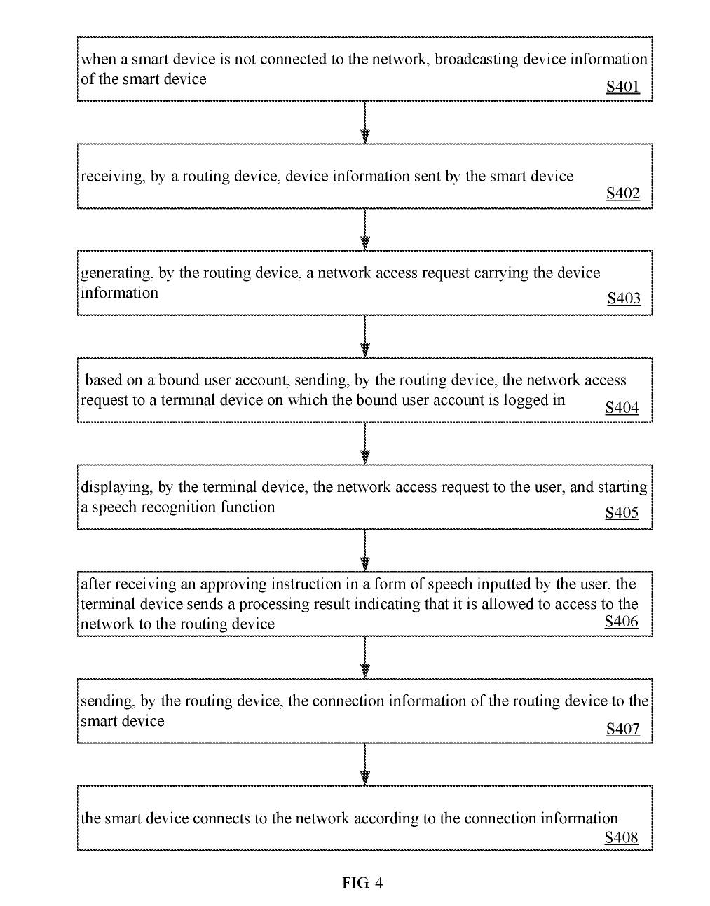

FIG. 4 shows a flow chart of another method for connecting to a network according to an example embodiment.

Referring to FIG. 4, the embodiment may be applied to the application scene shown in FIG. 1, and the method may include steps as follows.

In step S401, when a smart device is not connected to the network, device information of the smart device is broadcasted.

In the present embodiment, after being started, the smart device tries to access to the network, and when it is not able to access to the network, the smart device will broadcast the device information of the smart device.

In step S402, device information sent by the smart device is received by a routing device.

In the present embodiment, the routing device in the same local area network with the smart device receives the device information sent by the smart device.

In step S403, a network access request carrying the device information is generated by the routing device.

Based on the above step S402, after receiving the device information, the routing device may generate the network access request carrying the device information for the smart device.

In step S404, based on a bound user account, the network access request is sent by the routing device to a terminal device on which the bound user account is logged in.

In the present embodiment, the routing device may send the account information of the bound user account and the network access request to a server, and the network access request is forwarded by the server to the terminal device on which the user account is logged in according to the account information.

In step S405, the network access request is displayed by the terminal device to the user, and a speech recognition function is started.

In the present embodiment, after receiving the network access request, the terminal device may display the network access information to the user, and call a preset interface to start the speech recognition function.

In step S406, after receiving an approving instruction in a form of speech inputted by the user, the terminal device sends a processing result indicating that it is allowed to access to the network to the routing device.

In the present embodiment, the user may input the processing result with regard to the network access request in a form of speech, e.g. approving or refusing. When receiving an approving instruction in a form of speech inputted by the user, the terminal device may send a processing result indicating that it is allowed to access to the network to the routing device.

For example, after displaying the network access request to the user by the terminal device, the user may speak “connect to the network” to a microphone of the terminal device directly; after obtaining the speech of “connect to the network”, the terminal device determines that the speech is the approving instruction by recognition, and then the terminal device may send the processing result indicating that the network is allowed to be accessed to the routing device.

In step S407, the connection information of the routing device is sent by the routing device to the smart device.

Based on the above step S406, after receiving the processing result indicating that it is allowed to access to the network, the routing device may send the connection information of the routing device to the smart device, e.g. sending the SSID and an access password of the routing device to the smart device.

In step S408, the smart device connects to the network according to the connection information.

In the present embodiment, after receiving the connection information, the smart device may connect to the network according to the connection information, and starts related work after accessing to the network successfully.

In the above embodiments, the smart device and the routing device may realize the above procedure by referring to the method for connecting to a network provided in the embodiments of FIG. 1 and FIG. 2, which shall not be elaborated herein.

Corresponding to the embodiments of the method for connecting to a network, embodiments of a device for connecting to a network are also provided in the present disclosure.

FIG. 5 shows a block diagram of a device for connecting to a network according to an example embodiment.

Referring to FIG. 5, a device 500 for connecting to a network may be implemented at least partially in a routing device, including: an information receiving module 501, a request generating module 502, a request sending module 503, a result receiving module 504 and a connection sending module 505.

The information receiving module 501 is configured to receive device information sent by a smart device, in which the device information is broadcasted by the smart device when the smart device is not connected to the network.

The request generating module 502 is configured to generate a network access request carrying the device information received by the information receiving module 501.

The request sending module 503 is configured to send the network access request generated by the request generating module 502 to a terminal device on which a bound user account is logged in based on the bound user account.

The result receiving module 504 is configured to receive a processing result returned by the terminal device with regard to the network access request sent by the request sending module 503.

The connection sending module 505 is configured to send connection information of the routing device to the smart device when the processing result received by the result receiving module 504 indicates that the network is allowed to be accessed, such that the smart device connects to the network according to the connection information.

In the above embodiments, the routing device may send the network access request carrying the device information to the terminal device after receiving the device information sent by the smart device when the smart device is not connected to the network, and send the connection information for accessing to network to the smart device after receiving the result indicating that it is allowed to access to the network returned by the terminal device, such that the smart device may access to the network; in the entire process, the user may perform a network connection confirmation on the smart device via the terminal device without operating the smart device, which may be realized conveniently with good maneuverability, meanwhile, a geographical restriction may be overcome, and a remote control on the network connection of the smart device may be realized.

Thus, the present disclosure provides a device for connecting to a network. The device includes: an information receiving module, configured to receive device information sent by a smart device, where the device information is broadcasted by the smart device when the smart device is not connected to the network; a request generating module, configured to generate a network access request carrying the device information received by the information receiving module; a request sending module, configured to send the network access request generated by the request generating module to a terminal device on which a bound user account is logged in, based on the bound user account; a result receiving module, configured to receive a processing result returned by the terminal device with regard to the network access request sent by the request sending module; and a connection sending module, configured to send connection information of a routing device to the smart device under a condition that the processing result received by the result receiving module indicates that the network is allowed to be accessed, such that the smart device connects to the network according to the connection information.

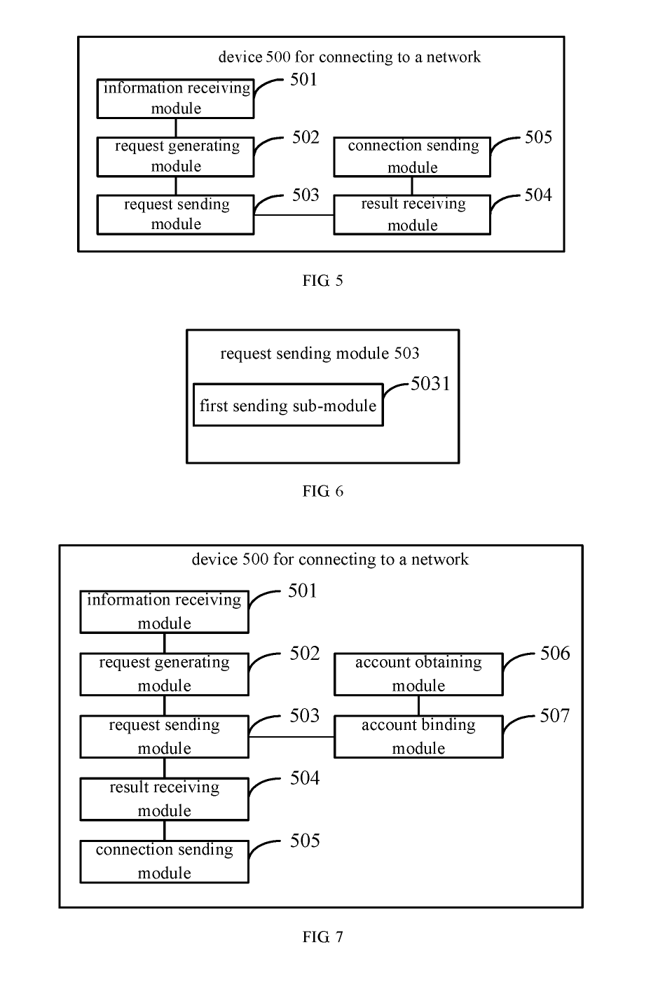

FIG. 6 shows a block diagram of another device for connecting to a network according to an example embodiment.

Referring to FIG. 6, the embodiment is based on the embodiment shown in FIG. 5, and the request sending module 503 includes: a first sending sub-module 5031.

The first sending sub-module 5031 is configured to send account information of the bound user account and the network access request to a server, such that the server forwards the network access request to the terminal device on which the bound user account is logged in according to the account information.

FIG. 7 shows a block diagram of another device for connecting to a network according to an example embodiment.

Referring to FIG. 7, the embodiment is based on the embodiment shown in FIG. 6, and the device 500 for connecting to a network further includes: an account obtaining module 506 and an account binding module 507.

The account obtaining module 506 is configured to obtain the account information inputted by a user.

The account binding module 507 is configured to send the account information obtained by the account obtaining module 506 to the server, such that the server builds a binding relationship between the bound user account corresponding to the account information and the routing device after the server verifies the account information successfully.

FIG. 8 shows a block diagram of another device for connecting to a network according to an example embodiment.

Referring to FIG. 8, the device 800 for connecting to a network may be applied in a smart device, including: a broadcasting module 801, a connection receiving module 802, and a network connection module 803.

The broadcasting module 801 is configured to broadcast device information of the smart device when the smart device is not connected to the network.

The connection receiving module 802 is configured to receive connection information sent by a routing device.

The network connection module 803 is configured to connect to the network according to the connection information received by the connection receiving module 802.

The connection information is sent by the routing device after receiving a processing result returned by a terminal device with regard to a network access request, in which the processing result indicates that the network is allowed to be accessed, and the network access request is generated by the routing device and carries the device information.

Thus, the present disclosure provides a device for connecting to a network. The device includes: a broadcasting module, configured to broadcast device information of a smart device when the smart device is not connected to the network; a connection receiving module, configured to receive connection information sent by a routing device; and a network connection module, configured to connect to the network according to the connection information received by the connection receiving module; where the connection information is sent by the routing device after receiving a processing result returned by the terminal device with regard to a network access request. The processing result indicates that the network is allowed to be accessed, and the network access request is generated by the routing device and carries the device information.

In the above embodiments, the routing device may send the network access request carrying the device information to the terminal device after receiving the device information sent by the smart device when the smart device is not connected to the network, and send the connection information for accessing to the network to the smart device after receiving the result indicating that it is allowed to access the network returned by the terminal device, such that the smart device may access to the network; in the entire process, the user may perform a network connection confirmation on the smart device via the terminal device without operating the smart device, which may be realized conveniently with good maneuverability, meanwhile, a geographical restriction may be overcome, and a remote control on the network connection of the smart device may be realized.

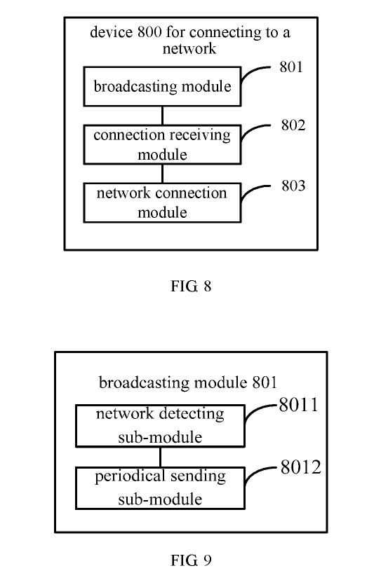

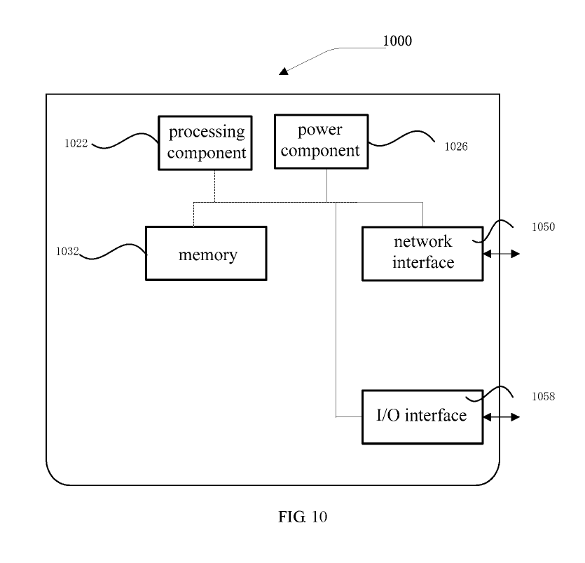

FIG. 9 shows a block diagram of another device for connecting to a network according to an example embodiment.

Referring to FIG. 9, the embodiment is based on the embodiment shown in FIG. 8, and the broadcasting module 801 may include: a network detecting sub-module 8011 and a periodical sending sub-module 8012.

The network detecting sub-module 8011 is configured to detect whether the smart device is able to connect to the network after the smart device is started.

The periodical sending sub-module 8012 is configured to broadcast the device information of the smart device periodically under a condition that the network detecting sub-module 8011 detects that the smart device is unable to connect to the network.

In the above embodiments, the smart device may periodically broadcast the device information of the smart device when the smart device is not connected to the network, so as to obtain the connection information of the routing device and to access to the network; in the entire process, the user need not to operate the smart device, which may be realized conveniently, such that the user experience is good.

Concerning the realization process of functions and effects of each unit of the above device, reference may be made to the realization process of corresponding steps in the above method, which shall not be elaborated herein.

For the device embodiments, since the device embodiments are basically corresponding to the method embodiments, the related parts may refer to the description of the method embodiments. The above-described device embodiment is merely exemplary, the units described as separated parts may be or may not be physically separated, the components displayed as units may be or may not be physical units, i.e. may be located at one place, or may be distributed on multiple network elements. Parts or all the modules thereof may be selected according to actual requirements to implement of the object of the present disclosure, which can be understood and implemented by those skilled in the without any inventive effort.

Correspondingly, a device for connecting to a network is also provided in the present disclosure. The device includes: a processor; and a memory, configured to store instructions executable by the processor; in which, the processor is configured to: receive device information sent by a smart device, in which the device information is broadcasted by the smart device when the smart device is not connected to the network; generate a network access request carrying the device information; based on a bound user account, send the network access request to a terminal device on which the bound user account is logged in; receive a processing result returned by the terminal device with regard to the network access request; and when the processing result indicates that the network is allowed to be accessed, send connection information of the routing device to the smart device, such that the smart device connects to the network according to the connection information.

Correspondingly, a non-temporary computer readable storage medium is also provided in the present disclosure, when the instructions in the storage medium is executed by a processor of a routing device, a method for connecting to a network can be executed by the routing device, and the method includes: receiving device information sent by a smart device, in which the device information is broadcasted by the smart device when the smart device is not connected to the network; generating a network access request carrying the device information; based on a bound user account, sending the network access request to a terminal device on which the bound user account is logged in; receiving a processing result returned by the terminal device with regard to the network access request; and when the processing result indicates that the network is allowed to be accessed, sending connection information of the routing device to the smart device, such that the smart device connects the network according to the connection information.

Correspondingly, a device for connecting to a network is also provided in the present disclosure. The device includes: a processor; and a memory, configured to store instructions executable by the processor; in which, the processor is configured to: when a smart device is not connected to the network, broadcast device information of the smart device; receive connection information sent by a routing device; and connect to the network according to the connection information; in which, the connection information is sent by the routing device after receiving a processing result returned by a terminal device with regard to a network access request in which the processing result indicates that the network is allowed to be accessed, and the network access request is generated by the routing device and carries the device information.

Correspondingly, a non-temporary computer readable storage medium is also provided in the present disclosure, when the instructions in the storage medium is executed by a processor of a smart device, a method for connecting to a network can be executed by the smart device, and the method includes: when the smart device is not connected to the network, broadcasting device information of the smart device; receiving connection information sent by a routing device; and connecting to the network according to the connection information; in which, the connection information is sent by the routing device after receiving a processing result returned by a terminal device with regard to a network access request, in which the processing result indicates that the network is allowed to be accessed, and the network access request is generated by the routing device and carries the device information.

FIG. 10 shows a block diagram suitable for a device 1000 for connecting to a network according to an example embodiment. For example, the device 1000 may be provided as a server. Referring to FIG. 10, the device 1000 includes a processing component 1022, further including one or more processors, and memory resource represented by a memory 1032 which is configured to store instructions executed by the processing component 1022, e.g. an application program. The application program stored in the memory 1032 may include one or more modules each of which is corresponding to a series of instructions. In addition, the processing component 1022 is configured to execute instructions so as to execute the above method for connecting to a network.

In this disclosure, the device 1000 may be implemented with one or more circuitries, which include one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components. The device 1000 may use the circuitries in combination with the other hardware or software components for performing the above described methods. Each module, sub-module, unit, or sub-unit disclosed above may be implemented at least partially using the one or more circuitries.

The device 1000 may also include: a power component 1026 configured to execute the power management of the device 1000, a wired or wireless network interface 1050 configured to connect the device 1000 to the network, and an input/output (I/O) interface 1058. The device 1000 may operate based on an operation system stored in the memory 1032, e.g. a Windows Server™, a Mac OS X™, a Unix™, a Linux™, a FreeBSD™ or similar.

The terminology used in the present disclosure is for the purpose of describing exemplary embodiments only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may be used herein to describe various information, the information should not be limited by these terms. These terms are only used to distinguish one category of information from another. For example, without departing from the scope of the present disclosure, first information may be termed as second information; and similarly, second information may also be termed as first information. As used herein, the term “if” may be understood to mean “when” or “upon” or “in response to” depending on the context.

Reference throughout this specification to “one embodiment,” “an embodiment,” “example embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may be combined in any suitable manner.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims

What is claimed is:

1. A method for connecting to a network, comprising:
receiving, by a routing device, device information sent by a smart device, wherein the device information is broadcasted by the smart device when the smart device is not connected to the network;
generating, by the routing device, a network access request carrying the device information;
sending, by the routing device, the network access request to a terminal device based on a bound user account;
receiving, by the routing device, a processing result returned by the terminal device with regard to the network access request; and
when the processing result indicates that the network is allowed to be accessed, sending, by the routing device, connection information of the routing device to the smart device, such that the smart device connects to the network according to the connection information.

2. The method according to claim 1, wherein sending the network access request to a terminal device based on the bound user account, comprises:
sending account information of the bound user account and the network access request to a server, such that the server forwards the network access request to the terminal device on which the bound user account is logged in according to the account information.

3. The method according to claim 2, further comprising:
obtaining the account information inputted by a user; and
sending the account information to the server, such that the server builds a binding relationship between the bound user account corresponding to the account information and the routing device after the server verifies the account information successfully.

4. A method, comprising:
broadcasting, by a smart device, device information of the smart device when the smart device is not connected to a network;
receiving, by the smart device, connection information sent by a routing device; and
connecting, by the smart device, to the network according to the connection information,
wherein, the connection information is sent by the routing device after receiving a processing result returned by a terminal device with regard to a network access request, wherein the processing result indicates that the network is allowed to be accessed, and the network access request is generated by the routing device and carries the device information.

5. The method according to claim 4, wherein broadcasting device information of the smart device when the smart device is not connected to the network comprises:
after the smart device is started, detecting whether the smart device is able to connect to the network; and
under a condition that the smart device is unable to connect to the network, broadcasting the device information of the smart device periodically.

6. A routing device, comprising:
a processor; and
a memory, configured to store instructions executable by the processor;
wherein, the processor is configured to:
receive device information that is broadcasted by a smart device when the smart device is not connected to a network;
generate a network access request carrying the device information;
based on a bound user account, send the network access request to a terminal device on which the bound user account is logged in;
receive a processing result returned by the terminal device with regard to the network access request; and
when the processing result indicates that the network is allowed to be accessed, send connection information of the routing device to the smart device, such that the smart device connects to the network according to the connection information.

7. The device according to claim 6, wherein the processor is configured to send the network access request to a terminal device on which the bound user account is logged in by an act of:
sending account information of the bound user account and the network access request to a server, such that the server forwards the network access request to the terminal device on which the bound user account is logged in according to the account information.

8. The device according to claim 7, wherein the processor is further configured to:
obtain the account information inputted by a user; and
send the account information to the server, such that the server builds a binding relationship between the bound user account corresponding to the account information and the routing device after the server verifies the account information successfully.

9. A smart device for connecting to a network, comprising:
a processor; and
a memory, configured to store instructions executable by the processor;
wherein, the processor is configured to:
when the smart device is not connected to the network, broadcast device information of the smart device;
receive connection information sent by a routing device; and
connect to the network according to the connection information;
wherein, the connection information is sent by the routing device after receiving a processing result returned by a terminal device with regard to a network access request, wherein the processing result indicates that the network is allowed to be accessed, and the network access request is generated by the routing device and carries the device information.

10. The device according to claim 9, wherein, the processor is configured to broadcast device information of the smart device by acts of:
after the smart device is started, detecting whether the smart device is able to connect to the network; and
under a condition that the smart device is unable to connect to the network, broadcasting the device information of the smart device periodically.
